(19) United States
(12) Patent Application Publication
(10) Pub. No.: US 2025/0270407 A1
(43) Pub. Date: Aug. 28, 2025

(54) MULTI-COMPONENT DIRECT TO METAL AND PLASTIC PRIMER SYSTEM

(71) Applicant: SWIMC LLC, Cleveland, OH (US)

(72) Inventors: Hong DING, Hudson, OH (US); Roberto J. RICCI, Beachwood, OH (US); Brian PAVIA, Aurora, OH (US)

(21) Appl. No.: 19/059,629

(22) Filed: Feb. 21, 2025

Related U.S. Application Data
(60) Provisional application No. 63/556,947, filed on Feb. 23, 2024.

(51) Int. Cl. C09D 5/00; C09D 133/14; C09D 163/00; C09D 167/00

(52) U.S. Cl. CPC C09D 5/002; C09D 133/14; C09D 163/00; C09D 167/00

(57) ABSTRACT

A multi-component primer system is provided. The system at least includes a first component and a second component. The first component comprises an acrylic resin, a polyester resin, and an epoxy resin. The acrylic resin and the polyester resin each have acetoacetoxy functionality. The second component comprises ketimines.

### CROSS REFERENCE TO RELATED APPLICATIONS

The present application is related to, and claims priority to, U.S. Provisional Application Ser. No. 63/556,947, filed Feb. 23, 2024, pending, the contents of which are incorporated herein by reference in their entirety.

### TECHNICAL FIELD

The present invention relates to a multi-component primer system comprising an acrylic resin having acetoacetoxy functionality, a polyester resin having acetoacetoxy functionality, an epoxy resin, and ketimines; coatings formed therefrom that adhere directly to plastic and metal; and methods of making the same.

### BACKGROUND OF THE INVENTION

The US paint and coatings industry includes more than 1,000 companies with combined annual sales in excess of $20 billion and continues to grow. A coatings formulation depends on, among other things, the material of the substrate that receives the coating. For example, in the automotive industry, a car's exterior comprises several metal and plastic parts. These parts are coated with a multi-layer system of coatings to protect the parts from various environmental conditions (e.g., humidity, temperature, sunlight, rain, snow, etc.) and from typical wear and tear (e.g., dents, scratches, etc.). A primer layer in a multi-layer system is ideally formulated to adhere to the material of the part and to also receive an overlying layer in the multi-layer system. However, it is difficult to achieve these properties, so the part is often pre-treated and/or comprises a pre-coat prior to the application of the primer layer to aid in the adhesion between the primer layer and the part.

In some applications, a polyurethane-based coating is used on automotive parts because polyurethanes are less prone to scratching, cracking, and other damage. One-component polyurethane coatings cure by crosslinking when exposed to water and/or heat. In two-component polyurethane coatings, a first component is mixed with a second component before applying the coating to a surface. Two-component polyurethane coatings typically do not require water or heat for curing, and instead may depend on the specific ratio of components mixed together and/or a crosslinker agent in the two-component polyurethane system for curing. Although two-component polyurethane coatings may have higher mechanical properties compared to one-component polyurethane systems, there are environmental, health, and safety concerns associated with the reaction upon mixing the two components to form a cured, two-component polyurethane coating. Additionally, two-component polyurethane coatings typically do not directly adhere to both metals and plastics, thereby necessitating an extra pre-treatment and/or pre-coat step prior to applying the coating over at least some of the automotive parts.

### SUMMARY OF THE INVENTION

In accordance with an embodiment of the present invention, a multi-component primer system is provided. The system may comprise a first component, a second component, and a third component. The first component includes an acrylic resin having acetoacetoxy functionality, a polyester resin having acetoacetoxy functionality, and an epoxy resin. The second component includes ketimines, and the third component includes reducer solvents.

In accordance with an embodiment of the present invention, a method of forming a coating is provided. The method includes mixing a first component with a second component to form a primer system. The first component includes an acrylic resin having acetoacetoxy functionality, a polyester resin having acetoacetoxy functionality, and an epoxy resin. The second component includes ketimines. This primer system can then be applied directly to a substrate, the substrate comprising a metal or a plastic. The primer system may cure over the substrate to form a primer layer on the substrate.

These and other objects of this invention, alone or in combination, have been satisfied by the discovery of a multi-component primer system comprising an acrylic, polyester, and/or epoxy resin. The multi-component primer system and coating composition made therefrom will be further described in the following detailed description and appended claims.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate, and styrene. Throughout this document, the word fragment “(meth)acryl” refers to both “methacryl” and “acryl.” For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds, but excludes aromatic carbon-carbon double bonds of aromatic rings.

The term “(co) polymer” as used herein includes both homopolymers (polymers containing units from a single monomer) and copolymers (polymers containing units from two or more different monomers), unless otherwise specifically stated.

The term “crosslinker” as used herein refers to a molecule capable of forming a covalent linkage between polymers or between two different regions of the same polymer.

The term “glass transition temperature” or “Tg” in the present invention can be measured by various conventional techniques including, for example, differential scanning calorimetry (“DSC”) or calculation by using a Fox equation. DSC data and methods described herein are in accordance with ASTM D6604-00.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

Embodiments of the invention disclosed herein relate to a multi-component primer system. The multi-component primer system may be used in any desired end use, including, but not limited to, the architectural, automotive, construction, marine, aerospace, general industrial, and similar industries. As will be described further herein, the multi-component primer system comprises several components. Each component provides various properties. The composition of each component and overall system are designed to balance the properties of presently available primer products. For example, Table 1 presents some of the pitfalls associated with two commercially available conventional primer products. Control A represents the performance of an epoxy-based primer system, whereas Control B represents the performance of a polyurethane-based primer system. As will be shown later in TABLE 2, the multi-component primer system described herein has an overall improved set of properties compared to Control A and Control B.

TABLE 1

| | Control A | Control B |
|---|---|---|
| COMPOSITION | (epoxy-based) | (polyurethane-based) |
| VOC | Over 450 g/L | Over 450 g/L |
| HAPS Compliant | No | No |
| Cure Conditions | Requires Baking | Ambient |
| Time to Sand | >8 Hours | 0.5-2 hours |
| Appearance | Moderate | Good |
| Impact Resistance | Poor | Good |
| Direct-to-Metal | Yes | No |
| Corrosion Resistance | OEM Approved | Poor |
| Water Resistance | OEM Approved | Poor |

The multi-component primer system comprises a first component, a second component, and a third component. The first component comprises an acrylic resin, a polyester resin, and an epoxy resin, where at least the acrylic resin and the polyester resin have acetoacetoxy functionality. The second component comprises a ketimine, and the third component comprises one or more reducer solvents. Upon the mixing of these three components, a primer coating is formed, which may be applied directly to a metal substrate and to a plastic substrate. The multi-component primer system has a fast cure time and may be cured in substantially dry environments without baking. The cured primer layer can be sanded quickly with good sandability and is sufficiently corrosion-resistant according to standards set by original equipment manufacturers (OEM) in the automotive industry. Additionally, upon mixing and curing, the multi-component primer system is REACH compliant, HAPs-compliant, global VOC compliant, and can meet other global OEM certifications.

In some embodiments, the first component comprises an acrylic resin having acetoacetoxy functionality, a polyester resin having acetoacetoxy functionality, and an epoxy resin. In some embodiments, the first component may comprise more of the acrylic resin than the polyester resin and also may comprise more of the polyester resin than the epoxy resin. For example, the first component may comprise about 25-50% of the acrylic resin by weight, about 10-40% of the polyester resin by weight, and about 10-40% of the epoxy resin by weight. Stated differently, in some embodiments, a ratio of the amount by weight of acrylic resin to polyester resin to epoxy resin in the first component is, preferably about 1:1:1, more preferably about 1:1.8:0.2, or even more preferable about 1:1.6:0.4. As described herein, these values and overall relationships may be adjusted based on desired properties. The acetoacetoxy equivalent weight of the acrylic resin may be in a range of between, for example, approximately 300 g/mol and approximately 1,500 g/mol or more preferably between approximately 400 g/mol and approximately 800 g/mol. The acetoacetoxy equivalent weight of the polyester resin may be in a range of between, for example, approximately 300 g/mol and approximately 1,500 g/mol, more preferably between approximately 300 g/mol and approximately 900 g/mol, or even more preferably between approximately 350 g/mol and approximately 500 g/mol. The epoxy resin can be modified with acetoacetoxy functionality or unmodified, meaning without acetoacetoxy functionality. For example, the epoxy resin may comprise at least one member selected from the group consisting of bisphenol A, bisphenol F, novolac and/or cycloaliphaticbased epoxies, polyester modified epoxy resins with acetoacetoxy and epoxide dual functionalities, epoxy reactive diluents, and/or epoxy silanes. The epoxy equivalent weight of the epoxy resin in the first component may be in a range of between, for example, approximately 140 g/mol and approximately 1,500 g/mol or more preferably between approximately 190 g/mol and approximately 700 g/mol. In embodiments where the epoxy resin is modified to have acetoacetoxy functionality, the acetoacetoxy equivalent weight of the epoxy resin in the first component may be in a range of between, for example, approximately 450 g/mol and approximately 1,200 g/mol or more preferably between approximately 470 g/mol and approximately 780 g/mol.

In some embodiments, the first component may also comprise a reactive diluent with acetoacetoxy functionality. In some such embodiments, the reactive diluents with acetoacetoxy functionality may be used instead of or in addition to epoxy reactive diluents to increase crosslinking density of the multi-component primer system upon mixing and curing. The reactive diluents with acetoacetoxy functionality also help reduce VOC levels in the multi-component primer system. In some embodiments, the VOC level is less than or equal to 250 g/L when excluding exempt solvents. Further, the first component of the multi-component primer system may include a millbase mixed with a mixing clear. The mixing clear may comprise the polyester resin having acetoacetoxy functionality and the epoxy resin. In some embodiments, the polyester resin and the epoxy resin may be prepared separately and then mixed together to form the mixing clear, while in some other embodiments, the polyester resin and the epoxy resin may be prepared together in a single pot to form the mixing clear. In some embodiments, a ratio of the epoxy resin to the polyester resin in the mixing clear is about 1:4 to about 1:1. The millbase may comprise the acrylic, polyester and epoxy resins having acetoacetoxy functionality as well as, for example, pigments, dispersants, anti-corrosives, solvents, and other suitable coating additives, such as, epoxy silanes. In some embodiments, the dispersant in the millbase may comprise phosphoric-, amino-, or urea-functionality, for example. The dispersant functionality may depend on how the dispersant reacts with other resins and additives in the first component. For example, phosphoric- and urea-based dispersants may be preferred over amino-based dispersants because the phosphoric- and urea-based dispersants do not interact with or consume epoxy groups compared to the amino-based dispersants.

As will be described further herein, during curing, crosslinking reactions occur between the various available functional groups in the resins of the first component when all components of the multi-component primer system are mixed together. Thus, the availability and number of the functional groups within each resin of the first component can influence the amount and rate of crosslinking, thereby influencing the overall properties of the multi-component primer system. Preferably, the main chains of the epoxy resins are terminated with epoxide groups and along the main chain backbone are side chains having terminal functional groups. The terminal functional groups can be any desired functional group capable of forming crosslinks, and are preferably acetoacetate (AcAc) groups. When the terminal functional groups comprise AcAc groups, the epoxy resin may be referred to as “modified.”

In some embodiments, the second component comprises a ketimine, such as an epoxy ketimine adduct, and/or a ketimine derived from a cycloaliphatic diamine, hexamethylene diamine and polyether amine. Further, the second component may comprise, for example, an animo silane and solvents. The ketimines may be based on a reaction product of a ketone and at least one primary amine. In some embodiments, the ketone used to form the ketimines may be acetone, methyl ethyl ketone, methyl propyl ketone, methyl isopropyl ketone (MIPK), diisopropyl ketone, methyl isobutyl ketone (MIBK), diisobutyl ketone, methyl amyl ketone, diisoamyl ketone, or some other suitable ketones. MIBK is considered a Hazardous Air Pollutant (HAP). When using MIBK, for the second component to be HAPS-compliant by the time the end user obtains the multi-component primer system, the ketimine in the second component will have less than or equal to 1% of MIBK. To be completely HAPs-free, the ketimines are preferably based on a reaction product of methyl isopropyl ketone (MIPK) and at least one amine. In some embodiments, the amine used to form the ketimines may be diethylene triamine, bishexamethylene triamine, or some other suitable amine. Further, the ketimines formed from the diethylene triamine and MIBK, MIPK, and/or other suitable ketone may further react with mono-, di-, and multifunctional epoxies to form di-, tetra-, and multifunctional epoxy ketimine adducts. The epoxy ketimine adducts may have an amino equivalent weight in a range of between, for example, preferably about 200 and about 900 g/mol, more preferably about 200 and about 500 g/mol, even more preferably about 200 and about 400 g/mol, and most preferably about 260 and 380 g/mol.

It will be appreciated that other amines reactive with the ketones to form ketimines are also within the scope of this disclosure given the resulting ketimines can be deblocked by moisture. For example, it is less preferable to use acetone-based ketimines in the second component. As another example, it is more preferable to use ketimines that have a steric hinderance closer to the imine group because as the steric hinderance (e.g., branched —CH₃ groups) gets closer to the imine group, the deblocking of the ketimine by moisture becomes more facile. For example, MIPK has more steric hindrance closer to the imine group than MIBK. Thus, the overall primer system may cure faster when using MIPK compared to when using MIBK because MIPK deblocks faster than MIBK. Other properties may change depending on which ketone is used. For example, the plateau modulus may rise while the glass temperature may decrease when MIPK is used in the multi-component system instead of MIBK. These relationships can be measured by various testing methods such as through Dynamic Mechanical Analysis and/or Fourier-Transform Infrared Spectroscopy. It will be appreciated that other ketones reactive with amines to form ketimines are also within the scope of this disclosure. For example, another suitable HAPS-compliant ketone is methyl propyl ketone-ultra high purity. For example, other HAPS-free ketones may include methyl ethyl ketone, methyl isoamyl ketones, diisopropyl ketone, diisobutyl ketones, t-butyl isobutyl ketones, or some other suitable structure.

When the first and second components are mixed together, several reactions occur. In some embodiments, the molar ratio of acetoacetoxy groups in the first component to ketimines in the second component is about 0.5 to 1.5 or more preferably about 1 to 1. In some embodiments, the molar ratio of epoxide groups in the first component to ketimines is in the second component preferably about 0.5 to 1.5 or more preferably about 1 to 1. The molar ratio of both of the acetoacetoxy and epoxide functionalities in the first component to ketimine functionality in the second component may be between 0.5 and 1.5, for example. A variation in these ratios of up to about 10 to 30% can also be used. After mixing, the primer system mixture may then be applied directly to a metal or plastic substrate as a coating, and over time, the primer coating cures to form a cured primer layer on the substrate. Upon mixing, the reaction between the first and second components begins in the presence of water. The water deblocks the ketimine to expose a primary amine (—NH₂) and ketone. The amine groups react with the available acetoacetoxy groups from the first component to form enamines to crosslink and cure resins having acetoacetoxy groups. The amine groups also react with available epoxide groups from the first component and/or the second component to crosslink and cure the epoxy resins such that there are no or substantially no epoxide groups remaining. The reaction between the amine groups and the acetoacetoxy groups is faster than the reaction between the amine groups and the epoxide groups. A deblocked ketimine chain may have several primary amines, wherein each primary amine on the chain reacts with one or more of the resins. Over time, a network of resins connected and intertwined by the deblocked ketimine chains forms and solvents evaporate to ultimately form a cured primer layer over a substrate. Progression of curing can be monitored over time by detecting the presence/increase of enamine. In some embodiments, the increase of enamine over time can be detected by, for example, Fourier Transform Infrared (FTIR) spectroscopy.

Thus, both of these reactions aid in the curing of the primer system over the substrate. The relative amount of the acetoacetoxy groups and epoxide groups in the multi-component primer system influences the speed of drying, interface tension, adhesion, and potlife. For example, to reduce the speed of curing and in turn to extend the potlife of the primer system, the number of epoxide groups may be increased. Preferably, the potlife of the primer system is between about 30 minutes to about 90 minutes, more preferably longer than one hour, or even more preferably, longer than two hours. This is because the reaction of amine groups with epoxide groups is relatively slow compared to other reactions in the primer system mixture. In some embodiments, when the first component is mixed with the second component comprising ketimines, the polyester resin having acetoacetoxy functionality cures faster than the acrylic resin having acetoacetoxy functionality. It has also been found that as the equivalent weight of acetoacetoxy in the polyester resin increases, the curing time decreases.

Similarly, the crosslinking density influences several properties. For example, a coating with a high crosslinking density is highly chemical resistant and hard but may not be very flexible, whereas a coating with a low crosslinking density may be flexible and water-resistant but may not be as resistant to chemicals. In some embodiments, the polyester resin with acetoacetoxy groups provides for tight crosslinking. Further, in some embodiments, more weight can be lost during curing of the multi-component primer system when the crosslinking density increases, and more solvents may become trapped within the cured primer coating when the crosslinking density increases. The change in weight can be measured by thermogravimetric analysis at temperatures greater than 100 degrees Celsius, in some embodiments.

Additionally, the relative amounts of acrylic resin, polyester resin, and epoxy resin in the multi-component primer system influences the flexibility, sandability, and adhesion of the primer coating on the substrate. For example, the acrylic resin provides good sanding properties, such as, no gumming on the sandpaper. In some implementations, the primer coating is ready to sand in preferably about 60 to about 90 minutes, more preferably in about 20 minutes to about 40 minutes, or even more preferably in about 25 minutes to about 30 minutes. The polyester resin provides flexibility in the cured primer layer for impact resistance and adhesion. Thus, when a coated car part is scratched or exposed to some other impact force, the cured primer coating comprising polyester is less likely to be removed (e.g., peel, chip, scratch, etc.) and expose the underlying substrate. In some embodiments, the polyester resin is di- or tri-functional. Additionally, the polyester resin may be linear or branched and include aromatic and aliphatic types of polyesters. Aliphatic polyester resins may provide flexibility, flow, and favorable texture of the multi-component primer system while aromatic polyester may provide favorable hardness, adhesion, and crosslinking density. For example, aromatic acetoacetoxy polyester resins provide a higher hardness than aliphatic acetoacetoxy polyester resins. The epoxy resin provides favorable adhesion, corrosion-resistant, and moisture-resistant (i.e., hydrophobic) properties. In some embodiments, epoxy resins also have a higher storage modulus at room temperature (e.g., about 25 degrees Celsius) and high temperature (e.g., greater than 25 degrees Celsius) compared to polyester resins because of the high crosslinking density provided by the epoxide groups. The storage modulus can be measured via dynamic mechanical analysis (DMA). In some embodiments, the DMA can be conducted on dry films having a thickness of about 3.5 mils and setting the DMA machine at 0.1 MPa and 2 Kelvin per minute heating. It will be appreciated that with different film thicknesses and testing conditions, the aforementioned relationship of the storage modulus between epoxy resins and polyester resins may change. Additionally, when the first component comprises epoxy silanes, interface adhesion between the substrate and any pigments in the multi-component primer system is improved. When the second component comprises amino silanes, adhesion between the multi-component primer system is also improved. It can be appreciated that the multi-component primer system can achieve several favorable properties without the use of isocyanates that may be harmful to health and the environment.

After the first, second, and third components are manufactured, a consumer may purchase the first component housed in a first container, a second component housed in a second container, and a third component housed in a third container. When a substrate is ready for coating, the first, second, and third components are mixed at a predetermined ratio. In some embodiments, the components may be mixed together with a paint stick, an industrial mixing machine, a shake-and-pour container, or some other suitable mixing technique. The VOC limit of the multi-component primer system may be about a total true VOC of 400 to about 410 g/L or VOC of 250 g/L not counting exempt solvent, or some other value to comply with OEM standards.

The multi-component primer system can be applied directly to metal and also directly to plastic without requiring an etch primer or surface treatment process on the substrate prior to application. For example, an etch primer undercoat is not arranged between the disclosed cured primer layer formed from the multi-component primer system and the substrate. The multi-component primer system can also be applied directly to several different kinds of plastics and metals. Thus, a car manufacturer, for example, may apply this one primer system to several exterior car parts made of different metal and plastic materials. Additionally, the viscosity of the multi-component primer system can be controlled upon mixing by the amount of the third component (also called a reducer solvent) added. Thus, this multi-component primer system can also be formulated for application via spraying, a brush, a roller, or some other suitable applicator. For spraying applications, for example, the viscosity may be less than about 22 seconds or more preferably in a range of between about 15 to about 18 s upon mixing, which is suitable for spraying applications. These viscosity measurements may be conducted using a Zahn Cup 2.

After application of the primer mixture coating onto the substrate, the primer mixture coating may cure to form a primer layer on the substrate. After about 25 minutes to about 35 minutes since its application, even without being fully cured, the primer layer may be sanded. In some other embodiments, the cured primer layer may not need to be sanded because the texture of the cured primer layer may already be sufficient to receive additional layers. Further, in some other embodiments, the time to sand may be about 20 minutes to about 40 minutes or about 60 minutes to about 90 minutes, for example. It will be appreciated that in some embodiments, at least one topcoat, such as a clearcoat, a basecoat then a clearcoat, or a single stage topcoat, may be applied to the cured primer layer.

As mentioned, water deblocks the ketimine to expose the primary amine, which is reactive with several of the resins in the multi-component primer system. Thus, the multi-component primer system may cure in a moist environment. The level of moisture in the environment may directly influence the speed of curing. For a more controlled cure, the second component of the multi-component primer system may comprise amino silanes. The amino silanes comprise amines (—NH₂) that are not blocked, and thus, are reactive with the acetoacetoxy groups; this reaction produces water as a byproduct. The water byproduct can then deblock the ketimine to expose more amines (—NH₂) for reactions with the acetoacetoxy groups and epoxide groups. Thus, when multi-component primer system comprises amino silanes, a moist environment is not necessary for curing. Instead, the multi-component primer system mixture may generate its own water for controlled curing. Therefore, the multi-component primer system may have a faster curing rate when amino silanes are present in the second component. The amino silanes also can act as a reactive diluent that aids in adhesion and reduces VOC levels. Other amino-based resins that may be used in the second component include cycloaliphatic amines, polyether amines, polyamides, or other suitable amino-based resins. Additionally, in certain formulations of the present invention, when the number of amines are increased, the impact resistance of the cured primer coating is improved while the delamination resistance during cyclic corrosion worsens. This multi-component primer system mixture also does not require a baking process for curing, which reduces manufacturing costs of an automobile by reducing energy consumption, reducing time, and eliminating the need for baking equipment after application of the primer mixture coating.

As discussed above and further herein, the multi-component primer system is formulated to achieve several favorable results. When compared to the various controls commercially available, it can be appreciated that while the multi-component primer system may have slightly less favorable results in some categories, the multi-component primer system has more consistent results in all categories and a better overall combination of results than either of the controls. For example, Table 2 illustrates how the multi-component primer system described herein has an overall superior rating compared to Control A and Control B. Each property in the first column was tested and scaled to a rating between 1.0 and 10.0 for each composition (with 1.0 being the worst and 10.0 being the best). As seen, not only does the multi-component primer system have an overall superior score, but also, the multi-component primer system has scores that all fall in the range between 7.5 and 10.0. This is a significantly improved range compared to Control A and B, each of which has several scores falling below 7.5, with each having one or more scores falling at 1.0. Notably, the multi-component primer system has the same sandability 10.0 score as Control B instead of the poor 1.0 score of Control A. Further, the multi-component system has around the same humidity, water immersion, corrosion (cyclic), and corrosion salt fog scores as Control A instead of the poor scores of Control B. Thus, the multi-component primer system provides an overall improved array of properties, combining the superior sandability performance of Control B with the superior water and corrosion resistance of Control A, all while having lower VOC levels than both of Control A and Control B.

TABLE 2

| | | Control A | Control B |
|---|---|---|---|
| | Multi-Component | (Epoxy- | (Polyurethane- |
| COMPOSITION | Primer System | based) | based) |
| Appearance | 8.0 | 9.5 | 10.0 |
| Pot Life | 7.5 | 10.0 | 8.0 |
| Sandability (Air Dry) | 10.0 | 1.0 | 10.0 |
| VOC (Global/Low) | 10.0 | 5.0 | 5.0 |
| Humidity | 9.0 | 9.0 | 3.0 |
| Water Immersion | 9.0 | 10.0 | 1.0 |
| Corrosion (Cyclic) | 8.0 | 10.0 | 1.0 |
| Corrosion Salt Fog | 9.0 | 10.0 | 4.0 |
| Impact Resistance | 10.0 | 6.0 | 9.0 |
| Total Score | 80.5 | 70.5 | 51.0 |

As mentioned above, the first component comprises an acrylic resin having acetoacetoxy functionality, which may comprise the same or similar polymers described in U.S. Pat. No. 6,297,320. U.S. Pat. No. 6,297,320 is incorporated herein by reference in its entirety. For example, the acetoacetoxy functional acrylic polymers useful in this multi-component primer system are those having an average of at least two pendant acetoacetoxy groups per molecule. The polymers can be conveniently prepared by addition polymerization of one or more unsaturated monomers. One practical approach to preparing these polymers involves the polymerization of acetoacetoxy functional unsaturated monomers, typically along with one or more other unsaturated copolymerizable monomers. One especially preferred acetoacetoxy functional monomer due to its reactivity and commercial availability, is acetoacetoxy ethyl methacrylate. Other unsaturated monomers that are useful for introducing acetoacetoxy functional groups include acetoacetoxy ethyl methacrylate, acetoacetoxy propyl methacrylate, allyl acetoacetate, acetoacetoxy butyl methacrylate, 2,3-di(acetoacetoxy) propyl methacrylate, etc. In general, it is practical to convert polymerizable hydroxy functional monomers into acetoacetoxy functional monomer by direct reaction with diketene or other suitable acetoacetoxy converting agent. See, for example, Journal of Coating Technology, vol. 62, p. 101 (1990) “Comparison of Methods for the Preparation of the Acetoacetylated Coating Resins.”

Alternatively, a hydroxy-functional polymer can be prepared by the free radical polymerization of hydroxy-functional unsaturated monomers and the resultant hydroxy-functional polymer can be converted to acetoacetoxy functional groups by direct reaction with diketene, by transesterification with suitable alkyl acetoacetates such as t-butyl acetoacetate, ethyl acetoacetate, or with the thermal reaction of 2,2,6-trimethyl-4H-1,3-dioxin-4-one.

The acetoacetoxy functional monomer will be present at a level of at least one percent by weight of the entire monomer mixture for the acrylic polymer, and typically will comprise from 10 to about 75%, and preferably 25 to about 50% of the entire monomer mixture. Typically, the acetoacetoxy functional monomers would be copolymerized with one or more monomers having ethylenic unsaturation such as:
(i) esters of acrylic, methacrylic, crotonic, tiglic, or other unsaturated acids such as: methyl acrylate, ethyl acrylate, propyl acrylate, isopropyl acrylate, butyl acrylate, isobutyl acrylate, ethylhexyl acrylate, amyl acrylate, 3,5,5-trimethylhexyl acrylate, methyl methacrylate, ethyl methacrylate, propyl methacrylate, isobornyl methacrylate, dimethylaminoethyl methacrylate, ethyl tiglate, methyl crotonate, ethyl crotonate, etc.;
(ii) vinyl compounds such as vinyl acetate, vinyl propionate, vinyl butyrate, vinyl isobutyrate, vinyl benzoate, vinyl m-chlorobenzoate, vinyl p-methoxybenzoate, vinyl alpha-chloroacetate, vinyl toluene, vinyl chloride, etc.;
(iii) styrene-based materials such as styrene, alpha-methyl styrene, alpha-ethyl styrene, alpha-bromo styrene, 2,6-dichlorostyrene, etc.;
(iv) allyl compounds such as allyl chloride, allyl acetate, allyl benzoate, allyl methacrylate, etc.;
(v) other copolymerizable unsaturated monomers such as acrylic acid, methacrylic acid, 2-hydroxy ethyl acrylate, acrylonitrile, methacrylonitrile, dimethyl maleate, isopropenyl acetate, isopropenyl isobutyrate, acrylamide, methacrylamide, and dienes such as 1,3-butadiene, etc.

The polymers are conveniently prepared by conventional free radical addition polymerization techniques. Frequently, the polymerization will be initiated by conventional initiators known in the art to generate a free radical such as azobis(isobutyronitrile), cumene hydroxperoxide, t-butyl perbenzoate, t-butyl peroctoate, t-amyl peroctoate, di-t-butyl peroxide, etc. Typically, the monomers are heated in the presence of the initiator and an inert solvent at temperatures ranging from about 35° C. to about 200° C. and especially 75° C. to 150° C., to affect the polymerization. The molecular weight of the polymer can be controlled, if desired, by the monomer and initiator selection, rate of addition, reaction temperature and time, and/or the use of chain transfer agents as is well known in the art. The number average molecular weight of the acetoacetoxy functional acrylic polymer will typically be at least 1,000 as determined by GPC. Typically, in those applications in which a relatively low viscosity is preferred (using the Zahn Cup 2), such as for spray applications at relatively low VOC levels, the number average molecular weight of the acetoacetoxy functional acrylic polymer preferably will be less than about 10,000, and the weight average molecular weight preferably will be less than about 20,000.

If the acetoacetoxy functional polymer is to be prepared by conversion of a hydroxy-functional polymer by the methods discussed above, then the hydroxy-functional monomer should be present at essentially the same levels preferred for the acetoacetoxy functional monomer.

As mentioned above, in some embodiments, the first component comprises an acetoacetate functional polyester. In some embodiments, the ratio of the acetoacetate functional acrylic to the acetoacetate functional polyester to the acetoacetate/epoxide dual functional epoxides by weight in the first component is preferably about 1:1:1, more preferably about 1:1.8:0.2, and even more preferably about 1:1.6:0.4. A variation in these ratios of up to about 10-20% can also be used. In some embodiments, the polyester is made with aliphatic monomers to form an aliphatic linear or branched polyester polyol. In some other embodiments, the polyester contains aromatic monomers. The formed polyester polyol is then reacted with t-butyl acetoacetate or ethyl acetoacetate and form an acetoacetate functional polyester. In some embodiments, the resulting polyester mixture may have an acetoacetoxy equivalent weight in a range of about 200 to about 1000. More preferably from about 300 to about 800 g/mol, more preferably about 300 to about 500 g/mol. In some embodiments, the resulting polyester may have a weight average molecular weight (Mw in Dalton) in a range of about 1,500 to about 15,000. Preferably from about 2,000 to about 10,000. Even more preferably from about 2,000 to about 5,000.

As mentioned above, in some embodiments, the first component comprises an epoxy resin having acetoacetoxy functionality. In some embodiments, these resins are made by ring-opening polymerization of e-caprolactone with an —OH containing epoxy resin, then reacts with t-butyl acetoacetate or ethyl acetoacetate to form an epoxide and acetoacetate dual functional polyester modified epoxy resin, preferably such a resin where the polyester component is a polycaprolactone based polyester. The nonvolatile matter is adjusted as t-butanol and ethanol are stripped off. In some embodiments, this reaction occurs at a temperature in a range of between, for example, preferably about 100 degrees Celsius and about 170 degrees Celsius, more preferably about 120 degrees Celsius and about 160 degrees Celsius, or even more preferably about 140 degrees Celsius and about 150 degrees Celsius. The resulting copolymer comprises both polyester and epoxy segments. For example, in some embodiments, the first component comprises mono-epoxide di-acetoacetate resins; di-epoxide mono-acetoacetate resins; polyester-blocked-epoxy copolymers with acetoacetoxy functionality but no epoxide functionality; or polyester-grafted-epoxy copolymers with di-epoxide and acetoacetoxy functionality at the chain end of the polyester side chains. In some embodiments, the resulting epoxy polyester copolymer may have an epoxy equivalent weight range of from about 500 g/mol to about 3200 g/mol. More preferably from about 500 g/mol to about 1300 g/mol. The copolymer may also have an acetoacetate equivalent weight range of from about 300 g/mol to about 1500 g/mol. More preferably from about 500 g/mol to about 800 g/mol.

As mentioned above, in some embodiments, the first component comprises reactive diluents. In some embodiments, reactive diluents with acetoacetoxy functionality used herein are mono-, di-, tri-, or tetra-functional. Non-limiting examples of commercially available reactive diluents with acetoacetoxy functionality include neopentyl glycol diacetoacetate, trimethylolopropane triacetoacetate, and pentaerythrityl tetraacetoacetate. Epoxy reactive diluents may be mono-, di-, or tri-functional. Non-limiting examples of epoxy reactive diluents include epoxy silanes, Cardolite® NC513, and Epon® 828.

As mentioned above, the second component may comprise ketimines. In some embodiments, representative amines that may be used to react with ketones to form the ketimines of the second component may be, for example, ethylene diamine, diethylene triamine, propylene diamine, tetramethylene diamine, 1,6-hexamethylene diamine, bis(6-aminohexyl) ether, tricyclodecane diamine, cyclohexyl-1,2,4-triamine, cyclohexyl-1,2,4,5-tetraamine, 3,4,5-triaminopyran, 3,4-diaminofuran, and cycloaliphatic diamines. Further, representative epoxies that further react with the ketimines include, for example, aromatic, aliphatic, linear, branched, novoac, and cyclic aliphatic epoxies. These representative epoxies may have an epoxy equivalent weight in a range of between, for example, approximately 140 g/mol and approximately 550 g/mol. Non-limiting examples of epoxies suitable for reaction with the ketimines include Cardura® E10, Cardolite® NC513, BisA epoxy resins, BisF and novolac epoxy resins.

In some embodiments, the ketimines are conveniently prepared by reacting a stoichiometric excess of the ketone with the polyamine in an azeotropic solvent and removing water as it is formed. In order to minimize side reactions, and to avoid delays due to prolonged processing, it is frequently desirable to avoid the prolonged heating necessary to remove all of the excess ketone and unreacted starting materials, provided that their presence does not adversely affect the performance of the final product. For example, as mentioned above, sometimes less than about 1% of the ketones remain in the product.

One preferred type of imine compound for reaction with acetoacetoxy functional materials in the practice of this invention is an adduct obtained by reacting an imine having an additional reactive group other than an imine, such as, preferably, an amine group with a compound, such as an epoxide, having one or more chemical groups or sites capable of reaction with the additional reactive group. For example, an imine obtained from the reaction of two moles of a ketone with a triamine having two primary and one secondary amine groups, such as diethylene triamine or bishexamethylene triamine, will have an unreacted secondary amine group which could be subsequently reacted with a mono and/or polyepoxide to produce the imine functional adduct. In some embodiments, the reaction between the aforementioned imine having an unreacted secondary amine group with the mono and/or polyepoxide may be conducted at a temperature between preferably 90 and 150 degrees Celsius, more preferably 100 and 130 degrees Celsius, or even more preferably 110 and 120 degrees Celsius. One especially preferred commercial imine having an additional reactive group is Amicure KT-22 which is the reaction product of diethylene triamine and methyl isobutyl ketone.

For reaction with the imines having unreacted amine groups, representative useful monoepoxides include the monoglycidyl ethers of aliphatic or aromatic alcohols such as butyl glycidyl ether, octyl glycidyl ether, nonyl glycidyl ether, decyl glydicyl ether, dodecyl glycidyl ether, p-tertbutylphenyl glycidyl ether, o-cresyl glycidyl ether, and 3-glycidoxypropyl trimethoxysilane. monoepoxy esters such as the glycidyl ester of versatic acid (commercially available as CARDURA® E10P Glycidyl Ester from Hexion), or the glycidyl esters of other acids such as tertiary-nonanoic acid, tertiary-decanoic acid, tertiary-undecanoic acid, etc. are also useful. Similarly, if desired, unsaturated monoepoxy esters such as glycidyl acrylate, glycidyl methacrylate or glycidyl laurate could be used. Additionally, monoepoxidized oils can also be used. Other useful monoepoxies include styrene oxide, cyclohexene oxide, 1,2-butene oxide, 2,3-butene oxide, 1,2-pentene oxide, 1,2-heptene oxide, 1,2-octene oxide, 1,2-nonene oxide, 1,2-decene oxide, and the like. When an imine having one secondary amine and two ketimine groups reacts with a mono-functional epoxy described in this paragraph, an epoxy ketimine adduct is obtained with di-functional ketimine groups.

When an imine having one secondary amine and two ketimine groups reacts with a di-functional epoxy, an epoxy ketimine adduct is obtained with tetra-functional ketimine groups. Di-functional epoxies includes, and not limited to, cycloaliphatic di-glycidyl ethers, bisphenol A or bisphenol F based di-glycidyl ethers. When an imine containing one secondary amine and two ketimine groups reacts with a multi-functional epoxy, an epoxy ketimine adduct is obtained with multi-functional ketimine groups. Multi-functional epoxies include, and not limited to, novolac epoxy resins.

Additionally, the first, second, and/or third components of the multi-component primer system may comprise several solvents. Non-limiting examples of suitable organic solvents for use in the water-based and/or solvent-based coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl alkyl ketones, ethyl alkyl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

The multi-component primer system of the present invention may also include other optional ingredients that do not adversely affect the multi-component primer system or a cured coating resulting therefrom. Such optional ingredients include, for example, catalysts, dyes, pigments, toners, extenders, fillers, lubricants, anticorrosion agents, flow control agents, thixotropic agents, dispersing agents, antioxidants, adhesion promoters, light stabilizers, surfactants, and mixtures thereof. Each optional ingredient is preferably included in a sufficient amount to serve its intended purpose, but not in such an amount to adversely affect the two-part non-isocyanate cure system or a cured coating resulting therefrom.

Additional, non-limiting examples of preparing polyester resins of the first component (Resin Example 1, 2, and 4) and the epoxy resins of the first component (Resin Example 3 and 5) are as follows. Additionally, preparing the multi-component primer system using the one or more Resin Examples are presented below in Coating Examples 1, 2, and 3. Data related to each Coating Example is then presented in TABLE 3.

### Resin Example 1 (Polyester)

To a reactor equipped with an agitator, packed column, condenser, receiver, nitrogen inlet, thermocouple, temperature controller and heating mantle, 128.3 grams of trimethylolpropane, 796.7 grams of neopentyl glycol, 793.7 grams of isophthalic acid, 281.3 grams of maleic anhydride and 1.31 grams of Fascat® 4100 were added. The mixture was gradually heated and held at a temperature sufficient to distill water off, until acid value reached to about 5 mg KOH/g solid. The reactor was cooled and 424.3 grams of tertiary butyl acetoacetate were added. The temperature was gradually ramped up to distill off tertiary butanol. The reactor was then cooled and 668.0 grams of methyl amyl ketone were added. The reaction mixture was cooled and filtered to a lined container. The resulting resin had a solids content of 75.4%, a density of 9.03 pound per gallon, a Gardener-Holdt viscosity of Z4, a number average molecular weight of 2600, and a weight average molecular weight of 15641.

### Resin Example 2 (Polyester)

To a reactor equipped with an agitator, packed column, condenser, receiver, nitrogen inlet, thermocouple, temperature controller and heating mantle, 201.8 grams of trimethylolpropane, 783.2 grams of neopentyl glycol, 624.1 grams of isophthalic acid, 295.0 grams of maleic anhydride, 115.9 grams of hexahydrophthalic anhydride and 1.31 grams of Fascat® 4100 were added. The mixture was gradually heated and held at a temperature sufficient to distill water off, until acid value reached to about 5 mg KOH/g solid The reactor was cooled and 703.9 grams of tertiary butyl acetoacetate were added. The temperature was gradually ramped up to distill off tertiary butanol. The reactor was then cooled and 727.2 grams of methyl amyl ketone were added. The reaction mixture was cooled and filtered to a lined container. The resulting resin had a solids content of 74.6%, a density of 8.98 pound per gallon, a Gardener-Holdt viscosity of Y+, a number average molecular weight of 2183, and a weight average molecular weight of 6698.

### Resin Example 3 (Epoxy)

To a reactor equipped with an agitator, condenser, nitrogen inlet, thermocouple, temperature controller and heating mantle, 2435.0 grams of Epon® 1001F, 365.0 grams of tertiary butyl acetoacetate and 1110.0 grams of methyl amyl ketone were added under nitrogen blanket. The mixture was gradually heated while distilling off tertiary butanol. The solution was cooled and filtered to a lined container. The resulting resin had a solids content of 71.7%, a density of 8.82 pound per gallon, a Gardener-Holdt viscosity of Z+, a number average molecular weight of 1971, and a weight average molecular weight of 4965.

### Resin Example 4 (Polyester)

To a reactor equipped with an agitator, packed column, condenser, receiver, nitrogen inlet, thermocouple, temperature controller and heating mantle, 101.7 grams of trimethylolpropane, 907.4 grams of neopentyl glycol, 628.8 grams of isophthalic acid, 148.6 grams of maleic anhydride, 233.6 grams of hexahydrophthalic anhydride and 1.31 grams of Fascat® 4100 were added. The mixture was gradually heated and held at a temperature sufficient to distill water off, until acid value reached to about 5 mg KOH/g solid. The reactor was cooled and 964.9 grams of tertiary butyl acetoacetate were added. The temperature was gradually ramped up to distill off tertiary butanol. The reactor was then cooled and 468.6 grams of n-butyl acetate were added. The reaction mixture was cooled and filtered to a lined container. The resulting resin had a solids content of 79.3%, a density of 9.24 pound per gallon, a Gardener-Holdt viscosity of V+, a number average molecular weight of 1384, and a weight average molecular weight of 2315.

### Resin Example 5 (Epoxy)

To a reactor equipped with an agitator, condenser, nitrogen inlet, thermocouple, temperature controller and heating mantle, 644.7 grams of Epon® 1001F, 273.5 grams of e-caprolactone and 0.92 grams of Fascat® 2003 were added under nitrogen blanket. The mixture was heated and allowed to exotherm. The reaction mixture was held at elevated temperature for several hours or until the solid content reached a plateau. The reactor was cooled and 332.8 grams of tertiary butyl acetoacetate were added to the reactor. The temperature was gradually ramped up to distill off tertiary butanol. The reactor was then cooled and 694.5 grams of n-butyl acetate were added, and solids content adjusted to 80%. The reaction mixture was cooled and filtered to a lined container. The resulting resin had a solids content of 74.2%, a density of 9.11 pound per gallon, a Gardener-Holdt viscosity of Z1+, a number average molecular weight of 3724, and a weight average molecular weight of 6742.

### Coating Example 1

A mill base was prepared by charging 61.6 grams of a commercial acetoacetate functional acrylic, 6.1 grams of Cardolite® NC513, 36.9 grams of Epon® 1001F that was cut to 80% in methyl ethyl ketone, 17.6 grams of Disperbyk® 103, and 8.8 grams of 3-glycidyloxypropyl) trimethoxysilane to a container and mixed on low speed before sifting 26.4 grams of TiO₂, 59.8 grams of Burgess 10, 139.6 grams of barium sulfate, 79.8 grams of talc, 39.9 grams of Halox® 430, and 21.1 grams of PM acetate into the reaction mixture under continuous mixing. Once all the pigments were added, the High Shear Disperser (HSD) was set to high and ran until a 6 Hegman fineness of grind was achieved.

A Part A of the primer was prepared in an appropriate container under low shear mixing, where 497.6 grams of the above mill base, 26.4 grams of a commercial acetoacetate functional acrylic, 70.6 grams of Resin Example 1, 2.6 grams of Cardolite® NC-513, 15.8 grams of Epon® 1001F that was cut to 80% in methyl ethyl ketone, and 26.4 grams of acetone were added. The dispersion was mixed on low shear mixer at a speed that produced a visible vortex.

Prior to applying the coating by spray, 10.1 grams of aminopropyl triethoxysilane, 161.7 grams of a commercial ketimine crosslinker, and a reducer mixture that contained 3.0 grams of dipropylene glycol methyl ether, 18.2 grams of n-butyl acetate, and 9.1 grams of PM acetate were mixed with the above Part A under low shear mixing. Alternately, a pre-weighed portion of the Part A coating mixture could be added to a suitable closable can and when ready to apply, the crosslinker can be weighed into the can, sealed and hand or machine shaken for a set period of time depending on the volume being prepared, to fully incorporate the crosslinker. Once proper mixing is achieved, the coating is applied to the desired final dry film thickness.

### Coating Example 2

A mill base was prepared by charging 204.3 grams of a commercial acetoacetate functional acrylic, 29.9 grams of Disperbyk® 161, 12.0 grams of n-butyl acetate, 32.5 grams of n-butyl propionate and 11.6 grams of 3-glycidyloxypropyl) trimethoxysilane to a container and mixing on low speed before sifting 3.1 grams of carbon black, 94.2 grams of talc, 85.5 grams of clay, 209.3 grams of TiO₂, 198.1 grams of barium sulfate, 20.2 grams of n-butyl acetate and 10.6 grams of methyl isobutyl ketone into the mixture under continuous mixing. Once all the pigments were added, the High Shear Disperser (HSD) was set to high and ran until a 6 Hegman fineness of grind was achieved.

A Part A of the primer was prepared in an appropriate container under low shear mixing, where 491.0 grams of the above mill base, 11.6 grams of Cardolite® NC-513, 93.1 grams of Resin Example 2, and 81.0 grams of Resin Example 3 were added. The dispersion was mixed on low shear mixing at a speed that produces a visible vortex.

Prior to applying the coating by spray, 111.6 grams of a commercial ketimine crosslinker was mixed with the above Part A under low shear mixing. Alternately, a pre-weighed portion of the Part A coating mixture could be added to a suitable closable can and when ready to apply, the crosslinker can be weighed into the can, sealed and hand or machine shaken for a set period of time depending on the volume being prepared, to fully incorporate the crosslinker. Once proper mixing is achieved, the coating is applied to the desired final dry film thickness.

### Coating Example 3

A mill base was prepared by charging 258.1 grams of a commercial acetoacetate functional acrylic, 41.0 grams of Disperbyk® 103, 15.0 grams of n-butyl acetate, 45.8 grams of n-butyl propionate and 27.5 grams of 3-glycidyloxypropyl) trimethoxysilane to a container and mixing on low speed before sifting 3.9 grams of carbon black, 58.8 grams of talc, 53.4 grams of clay, 183.0 grams of TiO₂, 237.7 grams of ZN AL phosphate, and 235.1 grams of barium sulfate into the mixture under continuous mixing. Once all the pigments were added, the High Shear Disperser (HSD) was set to high and ran until a 6 Hegman fineness of grind was achieved.

A Part A of the primer was prepared in an appropriate container under low shear mixing, where 579.7 grams of the above mill base, 13.7 grams of Cardolite® NC-513, 75.2 grams of Resin Example 4, 84.2 grams of Resin Example 5, and 133.3 grams of acetone were added. The dispersion was mixed on low shear mixing at a speed that produces a visible vortex.

Prior to applying the coating by spray, 113.9 grams of a commercial ketimine crosslinker was mixed with the above Part A under low shear mixing. Alternately, a pre-weighed portion of the Part A coating mixture could be added to a suitable closable can and when ready to apply, the crosslinker can be weighed into the can, sealed and hand or machine shaken for a set period of time depending on the volume being prepared, to fully incorporate the crosslinker. Once proper mixing is achieved, the coating is applied to the desired final dry film thickness.

Table 3 presents three examples of the multi-component primer system and provides their properties compared to commercially available primers.

TABLE 3

| | Primers | | | | | |
|---|---|---|---|---|---|---|
| | Coating | Coating | Coating | Commercial | Commercial | Commercial |
| | Example 1 | Example 2 | Example 3 | NISO | Epoxy Bake | Polyurethane |
| Part A Resins | AcAc Fn | AcAc Fn | AcAc Fn | AcAc Fn | | OH Fn Acrylic |
| | Acrylic | Acrylic | Acrylic | Acrylic | | |
| | Resin | Resin | Resin | | Epoxy #1 | Polycaprolactone |
| | Example 1 | Example 2 | Example 4 | | | |
| | Epon 1001F | Resin | Resin | Epon 1001F | Epoxy #2 | |
| | | Example 3 | Example 5 | | | |
| Part B | Ketimine | Ketimine | Ketimine | Ketimine | Ancamine 2432 | HDI Trimer |
| Crosslinker | | | | | | |

Primer Properties

| DFT. mil | 3.1 | 2.2 | 3.4 | 3.3 | | 2.6 | 2.2 | |
|---|---|---|---|---|---|---|---|---|
| Circular cure | Ambient Dry | Ambient Dry | Ambient Dry | Ambient Dry | | Bake 1 hr | Ambient Dry | |
| | | | | | | @ 140° F. | | |
| Dry touch | 25 min. | 27 min. | 13 min. | 46 | min. | | 13 | min |
| Tack free | 46 min. | 50 min. | 18 min. | 61 | min. | | 31 | min |
| Through Dry | 55 min. | 56 min. | 25 min. | 81 | min. | | 34 | min |
| Time to sand | 75 min. | 70 min. | 45 min. | 3 | hrs | 8+ hrs | 30-45 | min |
| | | | | | | if ambient | | |

| | | | | | | |
|---|---|---|---|---|---|---|
| Sandability | Fair | Good | Good | Good | Good | Good |
| Pendulum Hardness | 34.0 | 57.8 | 35.7 | 78.1 | 72.0 | 59.0 |
| (Konig) | | | | | | |
| Gloss (20°) | 1.5 | 8.2 | 9.1 | 7.3 | 1.6 | 33.8 |
| Gloss (60°) | 14.9 | 45.2 | 48.0 | 40.5 | 7.3 | 72.0 |
| Water Immersion | 96 Hr | Water | Water | Water | Water | Water |
| 15 Day @ 40° C. | Humidity | Immersion | Immersion | Immersion | Immersion | Immersion |
| | (Failed | 15 Day | 15 Day | 15 Day | 15 Day | 15 Day |
| | Water | @ 40° C. | @ 40° C. | @ 40° C. | @ 40° C. | @ 40° C. |
| | Immersion | | | | | |
| | early) | | | | | |
| 15 Day | No blister | No blister | No blister | one 1.0 mm. no | No blister | Failed early |
| observation | | | | other blister | | |
| Adhesion Initial | 100% | 98% | 100% | 15% & 30% | 100% | 0% |
| Adhesion 24 hr | 100% | 98% | 100% | 97% | 100% | 0% |
| Recovery | | | | | | |
| Key Performances | Adequate | Good sanding | Fast sanding | Slower sanding | Need to bake | Fast sanding |
| | sanding | speed | Excellent | Good DTM | to sand | Poor DTM |
| | speed | Good DTM | DTM | | Excellent DTM | |
| | Fair DTM | | | | | |

As seen in TABLE 3, the three coating examples according to the disclosed multi-component primer system are Coating Example 1, Coating Example 2, and Coating Example 3. The first component of Coating Example 1 is formulated with a commercially available acrylic resin having acetoacetoxy functionality, a polyester resin according to Resin Example 1 described above, and a commercially available epoxy resin, EPON® 1001F. The second component of Coating Example 1 is a commercially available ketimine. The first component of Coating Example 2 is formulated with a commercially available acrylic resin having acetoacetoxy functionality, a polyester resin according to Resin Example 2 described above, and an epoxy resin according to Resin Example 3 described above. The second component of Coating Example 2 is a commercially available ketimine. The first component of Coating Example 3 is formulated with a commercially available acrylic resin having acetoacetoxy functionality, a polyester resin according to Resin Example 4 described above, and an epoxy resin according to Resin Example 5 described above. The second component of Coating Example 3 is a commercially available ketimine. Each of the Coatings Examples 1-3 also comprise the third component of at least one reducer solvent. Additionally, compositions and properties of commercially available primers, including a commercially available non-isocyanate (NISO) epoxy primer, a commercially available epoxy bake primer, and a commercially available polyurethane primer, are provided in the last 3 columns of TABLE 3.

The primer properties dry film thickness (DFT) of each coating system in TABLE 3 was between 2.2 mil and 3.4 mil. Each coating system of TABLE 3 was prepared according to the methods discussed prior to TABLE 3 and applied directly to a metal substrate and subjected to typical test methods to collect the data present.

As indicated in TABLE 3, the Coating Examples 1-3 that contained a combination of an acrylic resin with acetoacetoxy functionality, a polyester resin, and an unmodified or modified epoxy performed better than all three commercial primers in achieving a favorable combination of properties that cannot be achieved with commercially available products: drying speed, time to sand, sandability, and direct-to-metal wet adhesion. When comparing Coating Example 1 with Coating Examples 2 and 3, the modified epoxy resins having acetoacetoxy functionality (Resin Example 3, Resin Example 5) provided a better overall group of coating properties and performance than the unmodified epoxy resin (EPON® 1001F). When comparing Coating Example 2 with Coating Example 3, the epoxy ester resin having acetoacetoxy functionality (Resin Example 5) showed better wet adhesion while maintaining fast sanding properties. While there is variation amongst the properties of each Coatings Example 1-3, it is clear that that each Coatings Example 1-3 comprising the acrylic resin having acetoacetoxy functionality, a polyester resin, and an epoxy resin crosslinked with a ketimine has superior properties over commercially available primers.

The following are non-limiting examples of some embodiments of the present invention:

Embodiment 1. A multi-component primer system comprising:
a first component comprising an acrylic resin having acetoacetoxy functionality, a polyester resin having acetoacetoxy functionality, and an epoxy resin; and
a second component comprising ketimines.

Embodiment 2. The multi-component primer system of Embodiment 1, further comprising a third component comprising a reducer solvent.

Embodiment 3. The multi-component primer system of one of Embodiment 1 or Embodiment 2, wherein a molar ratio of the acetoacetoxy and epoxide functionalities in the first component to ketimine functionality in the second component is between 0.5 and 1.5.

Embodiment. The multi-component primer system of any one of Embodiments 1 to 3, wherein the epoxy resin is at least one member selected from the group consisting of difunctional epoxy resins having acetoacetoxy functionality, difunctional epoxy resins, multi-functional epoxy resins, and epoxy silanes.

Embodiment 5. The multi-component primer system of any one of Embodiments 1 to 4, wherein the epoxy resin comprises a novolac resin.

Embodiment 6. The multi-component primer system of any one of Embodiments 1 to 5, wherein the first component comprises a millbase dispersed in a mixing clear, wherein the millbase comprises the acrylic resin, and wherein the mixing clear comprises the polyester resin and the epoxy resin.

Embodiment 7. The multi-component primer system of any one of Embodiments 1 to 6, wherein the ketimines are a reaction product of a methyl isobutyl ketone and at least one amine.

Embodiment 8. The multi-component primer system of any one of Embodiments 1 to 6, wherein the ketimines are a reaction product of a methyl isopropyl ketone and at least one amine.

Embodiment 9. The multi-component primer system of any one of Embodiments 1 to 8 wherein the epoxy resin of the first component comprises an epoxy resin having acetoacetoxy and epoxide dual functionalities, a polyester modified epoxy resin having acetoacetoxy and epoxide dual functionalities, and/or a polyester modified epoxy resin having acetoacetoxy functionality.

Embodiment 10. The multi-component primer system of any one of Embodiments 1 to 9, wherein the epoxy resin of the first component comprises a polyester modified epoxy resin having acetoacetoxy and epoxide dual functionalities and/or a polyester modified epoxy resin having acetoacetoxy functionality.

Embodiment 11. The multi-component primer system of Embodiment 10, wherein a polyester portion of the polyester modified epoxy resin comprises polycaprolactone.

Embodiment 12. The multi-component primer system of any one of Embodiments 1 to 10, wherein the epoxy resin comprises at least one of a mono-functional epoxy resin, a di-functional epoxy resin, a multi-functional epoxy, or an epoxy silane.

Embodiment 13. The multi-component primer system of any one of Embodiments 1 to 12, wherein the second component further comprises amino silanes.

Embodiment 14. The multi-component primer system of any one of Embodiments 1 to 13, wherein the second component comprises an epoxy ketimine adduct.

Embodiment 15. The multi-component primer system of any one of Embodiments 1 to 14, wherein the primer system is configured to cure in the presence of moisture.

Embodiment 16. The multi-component primer system of any one of Embodiments 1 to 14, wherein the primer system is configured to cure upon mixing of the first component, the second component, and the third component in a substantially dry environment.

Embodiment 17. The multi-component primer system of any one of Embodiments 1 to 16, wherein the primer system is configured to adhere directly to metal or directly to plastic.

Embodiment 18. A method of coating a substrate comprising:
mixing a first component with a second component to form a primer system, wherein the first component comprises an acrylic resin having acetoacetoxy functionality, a polyester resin having acetoacetoxy functionality, and an epoxy resin, and wherein the second component comprises ketimines;
applying the primer system directly to a substrate, the substrate comprising a metal or a plastic; and
curing the primer system over the substrate to form a primer layer over the substrate.

Embodiment 19. The method of Embodiment 18, wherein the primer system further comprises a third component, the third component comprising reducer solvents.

Embodiment 20. The method of one of Embodiment 18 or Embodiment 19, wherein the curing is performed by drying, and wherein after about 60 minutes to about 90 minutes, the primer layer may be at least partially cured for further processing.

Embodiment 21. The method of any one of Embodiments 18 to 20, further comprising:
sanding the primer layer; and
applying a topcoat to the sanded primer layer.

Embodiment 22. The method of any one of Embodiments 18 to 21, wherein the first component further comprises a millbase dispersed in a mixing clear, wherein the millbase comprises the acrylic resin, and wherein the mixing clear comprises the polyester resin and the epoxy resin.

Embodiment 23. The method of any one of Embodiments 18 to 22, wherein after mixing and prior to curing, the primer system has a pot life greater than 60 minutes.

Embodiment 24. The method of any one of Embodiments 18 to 23, wherein the second component further comprises amino silanes.

Embodiment 25. The method of any one of Embodiments 18 to 24, wherein the substrate comprises both the metal and the plastic.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification. In addition, although a particular feature of the invention may have been disclosed with respect to only one of several implementations, such feature may be combined with one or more other features of the other implementations as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A multi-component primer system comprising:
a first component comprising an acrylic resin having acetoacetoxy functionality, a polyester resin having acetoacetoxy functionality, and an epoxy resin; and
a second component comprising ketimines.

2. The multi-component primer system of claim 1, wherein a molar ratio of the acetoacetoxy and epoxide functionalities in the first component to ketimine functionality in the second component is between 0.5 and 1.5.

3. The multi-component primer system of one of claim 1, wherein the epoxy resin is at least one member selected from the group consisting of difunctional epoxy resins having acetoacetoxy functionality, difunctional epoxy resins, multi-functional epoxy resins, novolac resins, and epoxy silanes.

4. The multi-component primer system of claim 1, wherein the ketimines are a reaction product of a methyl isobutyl ketone and at least one amine or of a methyl isopropyl ketone and at least one amine.

5. The multi-component primer system of claim 1, wherein the epoxy resin of the first component comprises an epoxy resin having acetoacetoxy and epoxide dual functionalities, a polyester modified epoxy resin having acetoacetoxy and epoxide dual functionalities, and/or a polyester modified epoxy resin having acetoacetoxy functionality.

6. The multi-component primer system of claim 1, wherein the epoxy resin of the first component comprises a polyester modified epoxy resin having acetoacetoxy and epoxide dual functionalities, and/or a polyester modified epoxy resin having acetoacetoxy functionality.

7. The multi-component primer system of claim 6, wherein a polyester portion of the polyester modified epoxy resin comprises polycaprolactone.

8. The multi-component primer system of claim 1, wherein the epoxy resin comprises at least one of a mono-functional epoxy resin, a di-functional epoxy resin, a multi-functional epoxy, or an epoxy silane.

9. The multi-component primer system of claim 1, wherein the second component further comprises amino silanes.

10. The multi-component primer system of claim 1, wherein the second component comprises an epoxy ketimine adduct.

11. The multi-component primer system of claim 1, wherein the primer system is configured to cure in the presence of moisture.

12. The multi-component primer system of claim 1, wherein the primer system is configured to adhere directly to metal or directly to plastic.

13. The multi-component primer system of claim 1, further comprising a third component comprising a reducer solvent.

14. The multi-component primer system of claim 13, wherein the primer system is configured to cure upon mixing of the first component, the second component, and the third component in a substantially dry environment.

15. A method of coating a substrate comprising:
mixing a first component with a second component to form a primer system, wherein the first component comprises an acrylic resin having acetoacetoxy functionality, a polyester resin having acetoacetoxy functionality, and an epoxy resin, and wherein the second component comprises ketimines;
applying the primer system directly to the substrate, the substrate comprising a metal, a plastic, or both a metal and a plastic; and
curing the primer system over the substrate to form a primer layer over the substrate.

16. The method of claim 15, wherein the primer system further comprises a third component, the third component comprising reducer solvents.

17. The method of claim 15, wherein the curing is performed by drying, and wherein after about 60 minutes to about 90 minutes, the primer layer may be at least partially cured for sanding.

18. The method of claim 15, wherein the first component further comprises a millbase dispersed in a mixing clear, wherein the millbase comprises the acrylic resin, and wherein the mixing clear comprises the polyester resin and the epoxy resin.

19. The method of claim 15, wherein after mixing and prior to curing, the primer system has a pot life greater than 60 minutes.

20. The method of claim 15, wherein the second component further comprises amino silanes.
